(19) United States
(12) Patent Application Publication
(10) Pub. No.: US 2019/0362604 A1
(43) Pub. Date: Nov. 28, 2019

(54) POKER SYSTEM AND METHOD

(71) Applicant: Jack Huang, Pasadena, CA (US)

(72) Inventor: Jack Huang, Pasadena, CA (US)

(21) Appl. No.: 16/420,088

(22) Filed: May 22, 2019

Related U.S. Application Data
(60) Provisional application No. 62/675,081, filed on May 22, 2018.

(51) Int. Cl. G07F 17/32

(52) U.S. Cl. CPC G07F 17/3293; G07F 17/3262

(57) ABSTRACT

A method of playing a poker game include the steps of dealing cards to two or more players, wherein the respective dealt cards comprise a hand of that player, receiving a bet by each of the players, wherein collective bets comprise a pot, determining a value of each hand, comparing the value of each hand, awarding an amount of the pot to the player with a winning hand, and doffing a personal item by the player with the winning hand.

### CROSS-REFERENCE TO RELATED APPLICATIONS

The present application claims the benefit of U.S. Provisional Application Ser. No. 62/675,081, filed on May 22, 2018, specification of which is herein incorporated by reference for completeness of disclosure.

### BACKGROUND OF THE INVENTION

### Field of the Invention

Embodiments of the invention relates to community games. More specifically, the invention relates to a gaming method.

### Description of the Related Art

Games have been around since the early days of civilization. It may be enjoyed by the individual, friends, and family. Card games have been a particular interest for people. Poker and its many variations have been a favorite form of card game. Gambling has been an exciting component of poker.

The general aim of poker is to collect a five-card hand that is superior to the five-card hand of one or more players or to try to bet in such a way as to cause the other players to believe that their hand is inferior and subsequently “fold” (concede or turn in) their hand. The players compete against one another for one cumulative “pot” or sum of money, or chips, or tokens, or “E-Dollar” as in Entertainment Dollar Unit. Generally, the dealer or “house” draws a percentage, otherwise known as “the rake”, of each pot, thus generating revenue regardless of which player wins each hand.

There are many types of games within the poker family (such as Texas Hold'em, Seven-Card Stud, Draw Poker, Hi-low, and Omaha) all of which provide alternative formats for competing over a five-card hand. Typically, these games involve a standard 52-card deck, although some variations use multiple decks or add a few cards called jokers which can be used as a substitute for any card in the deck.

Despite the fun and exciting aspects of poker, the general betting scheme has been the same for many years and may have led to some boredom.

The proliferation of so many different variations of poker and the various use of joker cards are a sign that poker players crave change. A need exists for providing a new, exciting variation of poker.

To overcome the shortcomings with existing poker games, the present invention provides, in one or more embodiments, a poker system and method to mitigate or obviate one or more of the aforementioned problems. In addition, embodiments of the present invention provide a poker system that is enhances the enjoyment of not just the winner but also the other players. In the end, in one or more embodiments of the present invention provide for everyone to be a winner.

### BRIEF SUMMARY OF THE INVENTION

Embodiments of the present invention provide an added variation of poker. Traditionally the winner of a poker hand will win the pot, thereby leaving the other players with a feeling of loss. An embodiment of the current invention describes how when the player with the best hand wins the pot, however, in return that winning player dictates who, other participating player(s)/performer(s), give up a personal item. The variation of poker has several benefits and advantages over what is currently available. First, the added features add excitement to the game. Second, the added features foster a sense of sportsmanship and community. Third, because of the added sense of community, more people are able to enjoy the game of poker.

A method of playing a poker game include the steps of dealing cards to two or more players, wherein the respective dealt cards comprise a hand of that player, receiving a bet by each of the players, wherein collective bets comprise a pot, determining a value of each hand, comparing the value of each hand, awarding an amount of the pot to the player with a winning hand, and doffing a personal item by the player with the winning hand.

One of the players may be a dealer.

The players may receive cards from the dealer.

A guest may make a side bet with other guests.

The personal item may be an article of clothing.

The personal item may be a piece of jewelry.

The method may have additional step of performing.

The step of performing may include singing.

The step of performing may include dancing.

A method of playing a poker game include the steps of dealing cards to two more players, wherein the respective dealt cards comprise a hand of that player, directing actions of each respective player by a respective member, receiving a bet by each of the players, wherein collective bets comprise a pot, determining a value of each hand, comparing the value of each hand, awarding an amount of the pot to the player with a winning hand, and doffing a personal item by the player with the winning hand.

One of the players may be a dealer.

The players may receive cards from the dealer.

A guest may make a side bet with other guests.

The personal item may be an article of clothing.

The personal item may be a piece of jewelry.

The method may have another step of performing.

The step of performing may be singing.

The step of performing may be dancing.

A queue may be developed when there is more than one member that waits to direct a particular player.

A method of playing a poker game include the steps of dealing cards to two or more players, wherein the respective dealt cards comprise a hand of that player, receiving a bet by each of the players, wherein collective bets comprise a pot, determining a value of each hand, comparing the value of each hand, awarding an amount of the pot to the player with a winning hand, and doffing a personal item by the player chosen by the player with the winning hand.

This summary is provided to introduce a selection of concepts that are further described below in the detailed description. This summary is neither intended to identify key or essential features of the claimed subject matter, nor is it intended to be used in limiting the scope of the claimed subject matter.

### BRIEF DESCRIPTION OF THE DRAWINGS

The above and other aspects, features and advantages of the invention will be more apparent from the following more particular description thereof, presented in conjunction with the following drawings wherein:

FIG. 1 is a flowchart illustration of the method of the poker system in accordance with one or more embodiments of the present invention.

FIG. 2 is a flowchart illustration of the method of the poker system in accordance with one or more embodiments of the present invention.

FIG. 3 is a flowchart illustration of the method of the poker system in accordance with one or more embodiments of the present invention.

FIG. 4 illustrates a general-purpose computer and peripherals that when programmed as described herein may operate as a specially programmed computer capable of implementing one or more methods, apparatus and/or systems of the present invention.

### DETAILED DESCRIPTION

The present invention comprising a poker system and method will now be described. Features of the inventive concept and methods of accomplishing the same may be understood more readily by reference to the following detailed description of embodiments and the accompanying drawings.

The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements may be exaggerated for clarity.

It should be noted that for the purposes of this application the term “doff” or “doffing” are not intended to be limited to the removing of clothing but rather should be understood as extending to any and all items that may be on the person and that accomplish one or more of the purposes described.

Embodiments of the present invention provide an added variation to the game poker. The variation of poker has several benefits and advantages over what is currently available. First, the added features add excitement to the game. Second, the added features foster a sense of sportsmanship and community. Third, because of the added sense of community, more people are able to enjoy the game of poker.

Embodiments included herein describe an improvement on the current game of poker. Traditionally the winner of a poker hand will win the pot, thereby leaving the other players with a feeling of loss. An embodiment of the current invention describes how when the player with the best hand wins the pot, however, in return that player gives up a personal item, as discussed herein. As such, there is a better sense of equality and karma that leads to a more fun experience. Furthermore, the player may direct another person, player, or performer to play in their place. As such, when the player wins the hand, the performer may act as surrogate and give up a personal item in the place of the player. Not only does this lead to more fun but it encourages a better sense of community and giving. In another embodiment, the surrogate performer may not play the game of poker but they may be designated as the one who gives up a personal item when the player wins the hand.

The giving of the personal item may be anything. As a non-limiting example, the personal item could be simple as a pair of glasses, gloves, shoes, money, shirts, pants, etc. It may also be the giving up of personal time to include a dance or performance.

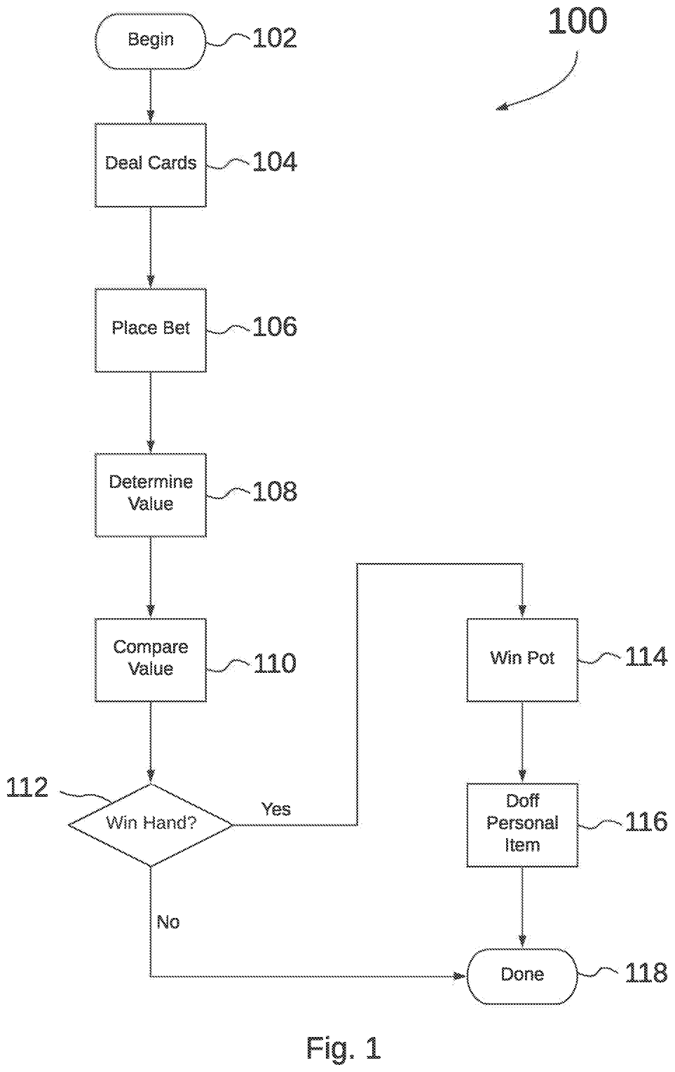

One or more embodiments of the present invention will now be described with references to FIGS. 1-4.

FIG. 1 is an illustration of a method 100 for a poker system and method with one or more embodiments of the present invention. As illustrated, the process begins at step 102 by the players gathering to play poker.

In step 104, the poker game starts when the dealer distributes cards to each of the players. Depending on the type of game, each player receives a number of cards. The player may look at their cards at this point and decide how to proceed.

In the following descriptions, a poker game is to be used for illustrative purposes only. Those of skill in the art would appreciate that the systems and methods described herein would be applicable to other types of industries and subject matters and thus are not limited to embodiments described herein.

Returning back to FIG. 1, in step 106, the player may choose to place a wager on the table based on their hand. If they feel they do not have a good hand, then they can fold or give up. Conversely, even if they have a bad hand, they may choose to bluff or pretend to have a better hand than what it appears.

However, at step 108 a determination is made of the value of the hand that the player holds. The value of the hand could be a great hand or a weak hand. As previously stated, the determination is made whether to fold, bluff, or to keep on going.

At step 110, when the players are required to show their hand, the players will then compare the value of their hand in relation to the hands of the other players.

At step 112, if a player does not have the highest value hand in relation to the hands of the other players then that player has lost the hand and is no longer in the game and is done at step 118.

Conversely, if the player has the highest value hand in relation to the other player's hands, then that player has won.

At step 114, the player with the wining hand collects the pot or the wagers of all of the players.

In addition to winning the pot at step 114, at step 116, the player doffs or removes a personal item.

The hand concludes and is done at step 118.

In the following example, Texas Hold'em will be discussed, however, it is only for illustrative purposes for this application. As such, any other form or variation of poker may be used. As a non-limiting example, any variation of Draw Poker like Five Card Draw Poker may be used, such as 5 Card Draw Dogbutt Poker, 5 Card Draw Anaconda Poker, 5 Card Draw Louisiana Lo-Flop Poker, 5 Card Draw Jacks or Better Poker, 5 Card Draw Monkey Love Poker, 5 Card Draw Double Draw Poker, 5 Card Draw Don Juan Poker etc.

Moreover, as a non-limiting example, any variation of Stud poker may be used such as Five Card Stud, such as 5 Card Stud Soko Poker, 5 Card Stud Balls Poker, 5 Card stud Indian Poker, 5 Card Stud Satan Poker, 5 Card Stud Best Flush Poker, 5 Card Stud Studded Guts Poker; or any variation of Seven Card Stud may be used, such as, 7 Card Stud No Limit Poker, 7 card Stud Pot Limit Poker, 7 card Stud Limit Poker, 7 card Stud Hi Low Poker, 7 card Stud Baseball Poker, 7 card Stud Follow The Queen Poker, 7 Card Stud San Francisco Poker, 7 Card Stud Razz Poker, 7 Card Stud Wall Street Poker, 7 Card Stud English Stud Poker, 7 Card Stud Sequence Poker, 7 Card Stud Six Kick Poker, 7 Card Stud Have a Heart Poker, 7 Card Stud Fourplay Poker, 7 Card Stud Black Mariah Poker, 7 Card Stud Chicago Poker, 7 Card Stud Russian Revolution Poker.

Also, any variation of Community card poker such as Texas Hold'em and Omaha Hold'em may be used.

The above examples are not used to limit the ideas and features of this application, however, any variation of poker or any other card game or any mixed variation or mixed games may be used.

A standard game of poker is discussed. More specifically, Texas Hold'em. Texas Hold'em is considered a game of community cards. To begin the game, the dealer deals cards to the players—a single card at a time to each player, rotating around the table, until each player has two cards. The two cards are known as hole cards. The player keeps their cards concealed until the end of all of the betting rounds, which is called the showdown. After the hole cards are dealt, there is typically a betting round. The dealer then deals five community cards in a 3-1-1 sequence (i.e. 3 cards, followed by 1 card then followed by 1 card). The five cards are displayed in the middle of the table. These community cards are used in conjunction the player's two hole cards in order to make the best five-card holding. The player who wins Texas Hold'em is the player with the best five-card hand.

Starting with the player to the left of the dealer button, the game moves clockwise around the poker table. The two players to the immediate left of the button are required to post a small blind and a large blind to initiate the betting. The button indicates which player at the table is the acting dealer. In Texas Hold'em, the player on button, or last active player closest to the button, receives last action on all post-flop streets of play.

Once a hand is complete, the button moves one position to the left and a new dealer is designated.

The dealer button not only designates the dealer but also indicates which player begins the wagering with the small and big blind. The player to the left of the dealer button receives the first card and every player at the table receives a card until each player has received two cards.

From there, action occurs on multiple streets: pre-flop, the flop, the turn and the river.

There are two types of blinds, the small and big blind. The player immediately to the left of the dealer button posts the small blind, and the player immediately left to that person posts the big blind. The small blind is generally a smaller wager than the big blind.

The two players who are required to post the small and big blind are required to post blind or forced bets that begin the round. The forced bets are necessary in order to keep the game moving. In certain situation like tournaments, the blinds are raised at regular intervals. This requires the players to continue to bet and facilitates the game until there's a winner.

The first three community cards that are dealt are called the “flop.” The fourth community card is called the “turn.” The fifth and final community card dealt is called the “river.” These five community cards are visible for every player to see. Once all of the five cards are down, the players aim to make the best five-card combination from these seven cards. The player's hole cards may be used in combination with the three community cards. Another option is to use one hole card in combination with four community cards. Still another option is not to use any of the player's hole cards and use all of the five community cards as the player's hand. The player with the best combination of cards wins the pot.

In Texas Hold'em, there are four rounds of betting. The first betting round of betting takes place once the hole cards have been dealt to all of the players; this is called the “pre-flop.” The player to the left of the player who posted the big blind commences action. That player has three options, call, raise or fold. If the player chooses to call, then that player matches the amount of the big blind. If the player chooses to raise, then that player increases the bet. If the player chooses to fold, then that player adds nothing to the pot and throws away their hand. If the player folds then they are no longer eligible to win the current hand and waits for the next deal.

There is strategy in terms of betting. One may decide to raise even if that player does not have a good hand. This is usually done to psychologically gain an advantage for future rounds. This is called “bluffing.” Conversely, the player may decide to call even if the player has an excellent hand. Once again, this may be done to gain a psychological advantage.

The second betting round occurs after the first pre-flop betting round has been completed. The unique part of the second betting round is that it takes place after the first three community cards have been dealt face up, i.e. after the flop. In addition, the player has another option. The player may call, fold, and raise, but in this round they may also check. A player may check if there is no bet during the current round. A check is to decline the chance to bet and is subsequently passed to the next player.

The next round of betting is called the third betting round. The fourth community card or the turn is dealt face up and a new round of betting starts. Once again, the players have an option to call, fold, raise, or check.

The last round or the final betting round begins after the fifth community card or the river is dealt face up. Again, the players have the option call, fold, raise, or check. After all the betting has been completed, the remaining players reveal their cards to determine the winner, this is called the showdown.

The player with the best hand wins the showdown and consequently the pot.

During the showdown, the value of each hand is determined. Each player's hand is compared to the hand of the other players. The player who wins Texas Hold'em is the player with the best five-card hand.

The player with the winning hand is awarded an amount of the pot. The exact amount may depend on the rules of the game, casino, or the house. The house may impose a commission for each pot. As a non-limiting example, all winning bets may be charged a 5% commission, which will be collected immediately by the dealer. The commission amount may be higher or lower than 5%. The commission may be a straight amount. As a non-limiting example, it may be $20 for each pot. In the alternative, the house may collect a combination of a straight commission along with a percentage of the pot. As such, the house may collect $20 and then take an additional 5% of the pot.

A personal item may be doffed by the player with the winning hand, or to be designating by the player with the winning hand. For the purposes of this application and description, doff may be defined as the act of removing something from the person's possession. As a non-limiting example, the personal item that is removed from the person may be a shirt, pants, dress, shoes, stockings, underwear, skirt, hats, gloves, etc. Also, it may be non-clothing items such as glasses, jewelry, necklaces, earrings, bracelets, etc. In addition, the personal items may be or related to costumes, uniforms, etc.

When the player with the winning hand wins a portion of the pot, then that player may proceed to doff a personal item. As such, in the spirit of giving, that player may give that personal item to another player, the house, or any other guest. Then again, that player may decide to keep the personal item after the player temporarily removes it from their immediate possession.

In addition to the removing of the personal item, the player may make it fun and playful. The player may perform while removing a personal item. As a non-limiting example, the performance may be dancing, singing, a lap dance, playing a musical instrument, a spontaneous expression, painting, etc. The player may perform while removing a personal item such as an item of clothing or jewelry.

One of the players may act or designated as a dealer. As such, if one of the players is a dealer, then that player may act to deal the cards to the other players. In the alternative, the House-Dealer may be provided by the house. If the house provides the dealer, then the job of the dealer would be to deal the cards and keep the play in order. Regardless of whether the house provides a dealer to deal cards, in the game of Texas Hold'em, there may still be a dealer button, and be rotated 1 player at a time, clockwise position. The dealer button would then designate the identity of the dealer. Although the player who is designated as the dealer would not actually physically deal cards but it would indicate which player begins the wagering with the small and big blind. The player to the left of the dealer button receives the first card and every player at the table receives a card until each player has received two cards.

In another embodiment, the guests may make side bets with other guests. For the purpose of this application and illustration, guest may be defined as anyone who is not a player who is currently engaged at the poker table. In addition, players may make side bets with other players. Also, there may be side bets made with a combination of players and guests.

The players may place a side bet on the table or by some other means. The guest may have a separate section or some sort of computer program based system where they are able to place a bet (only once, at the beginning of each deal, before any cards have been dealt). After the current poker game is over, and the five community cards have been dealt, the players with the winning hands may receive a portion of the independent side bet pot, independent of the current poker game. The award amount for the side bet may be predetermined and may depend on the best poker hand that is made with the five community cards. If the underlying game ends without five community cards being dealt, the remaining community cards may be dealt or the side bets may be carried over to the next game until five community cards are dealt.

A progressive pot may also be accumulated for splitting among the side bet players in the event a straight flush, four of a kind, or other improbably hand is obtained by the community cards. Such a progressive pot may become very high and draw new players to the game.

In another embodiment, guests may also place side bets on the community cards, allowing many guests to be indirectly involved in the game. This does not affect the underlying game.

If the game is played live, then the players at the table may have special or different chips from those being played at the table for the current game. In addition, those special chips may be placed on a different section of the poker table.

In a similar fashion, if the game is played live, the guests may accumulate their bets over at a different table and make wagers in a similar fashion.

In another embodiment, another method of playing a poker game is described. The method of playing a poker game is similar to the embodiment described previously. The poker game may include dealing cards to two more players, where the respective dealt cards comprise a hand of that player. As a non-limiting example, if a game of Texas Hold'em poker is played, two or more players are dealt a card and the dealer subsequently deals cards to each player, one card at a time, rotating around the table, until each player has two cards. The play is continued with a bet by each of the players, wherein collective bets comprise a pot. Once all of the bets are collected, then each of the players' hands are determined. Next, the values of the hands are compared. The player with the winning hand is awarded an amount of the pot.

In this embodiment a member directs the actions of a player. For the purposes of this application and for illustration purposes, a member may be defined as a person who is part of the gaming community. As non-limiting examples, the member may be a dues paying member of the group, a non-dues paying member, a guest of a dues paying member or guest of a non-dues paying member, a visitor, physically present at the game, not physically present at the game, virtually present at the game, a person who is engaged through the use of a computer system, a person who is remotely active with the game, etc. In addition, the member may be paired up with the player before the game or may be paired up well before the game. The pair may continue their relationship throughout the entire series of game or just for one hand.

Furthermore, for the purposes of this application and for illustration purposes, a player may be defined as someone who is physically handling the cards to play the poker game.

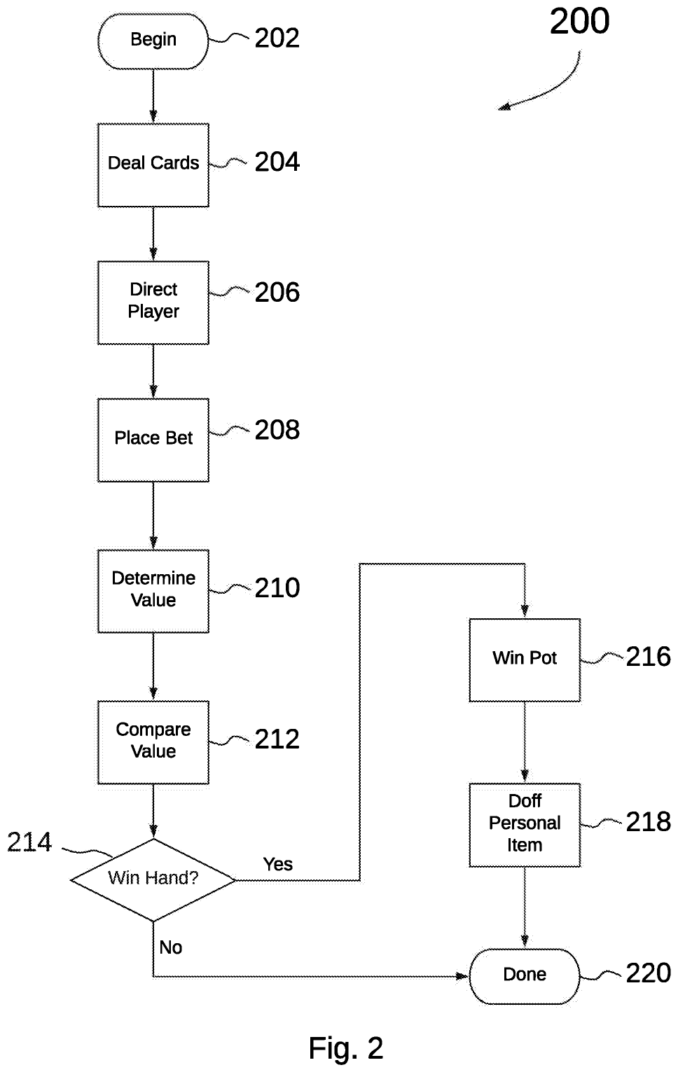

FIG. 2 is an illustration of a method 200 for a poker system and method with one or more embodiments of the present invention. As illustrated, the process begins at step 202 by the players gathering to play poker.

In step 204, the poker game starts when the dealer distributes cards to each of the players. Depending on the type of game, each player receives a number of cards.

In step 206, a member directs the actions of a player. The definition of a member was previously discussed. For the purposes of this application and for illustration purposes in this non-limiting example, a member may be another person present at the game and sits next to the player and communicates with the player by whispering in the player's ear.

In step 208, the member may choose to place a wager on the table based on their hand. If they feel they do not have a good hand, then they can fold or give up. Conversely, even if they have a bad hand, they may choose to bluff or pretend to have a better hand than what it appears. Accordingly, the member may direct the player to place a certain bet.

However, at step 210 a determination is made the value of the hand that the member/player holds. The value of the hand could be a great hand or a weak hand. As previously stated, the determination is made whether to fold, bluff, or to keep on going.

At step 212, when the players are required to show their hand, the members/players will then compare the value of their hand in relation to the hands of the other members/players.

At step 214, if a member/player does not have the highest value hand in relation to the hands of the other member/players then that member/player has lost the hand and is no longer in the game and is done at step 220.

Conversely, if the member/player has the highest value hand in relation to the other member's/player's hands, then that member/player has won.

At step 216, the member with the wining hand collects the pot or the wagers of all of the members.

In this embodiment, the member collects the pot or wagers at step 216, and then the player doffs or removes a personal item at step 218.

The hand concludes and is done at step 220.

As non-limiting examples, a member may communicate with the player by any means available such as using portable communication devices, computer-based communication means, or physically being present in the same room and communicating with the player.

Moreover, the member may communicate with the player remotely by the use of a chat room. There may be the use of a special website or some, text messaging, or some other means of interactive communication. This may prove to be more fun. The communication between the player and member may entail spunky banter and may be more stimulating and add to the experience.

By communicating with the player, the member may direct the player. The member may consult with the player to make decisions on how to proceed. Moreover, they may strategize together to form a team. Further, there may be more than one member who directs or interacts with the player during the hand or game. There may be the possibility of groups of members and players to form teams.

The member may communicate with the player and direct the player on how to player the hand of poker. The member may interact or play with the player for a hand, for the duration of the game, or for some sort of predetermined time limit. As previously discussed through the use of Texas Hold'em as a non-limiting and illustrative example of poker. Like the conventional game of poker, the player/member with the best or winning hand will be awarded an amount of the pot.

However, unlike the conventional game of poker, the player with the winning hand may doff a personal item or designate another performer to doff a personal item.

As previously defined, for the purposes of this application and description, doff may be defined as the act of removing something from the person's possession. As a non-limiting example, the personal item that is removed from the person may be a shirt, pants, dress, shoes, stockings, underwear, skirt, hats, gloves, etc. Also, it may be non-clothing items such as glasses, jewelry, necklaces, earrings, bracelets, etc. In addition, the personal items may be or related to costumes, uniforms, etc.

When the player with the winning hand wins a portion of the pot, then that player may proceed to doff a personal item. As such, in the spirit of giving, that player may give that personal item to another player, the house, or any other guest. Then again, that player may decide to keep the personal item after the player temporarily removes it from their immediate possession.

In addition to the removing of the personal item, the player may make it fun and playful. The player may perform while removing a personal item. As a non-limiting example, the performance may be dancing, singing, a lap dance, playing a musical instrument, a spontaneous expression, painting, etc. The player may perform while removing a personal item such as an item of clothing or jewelry.

Moreover, the member may direct the player and/or performer to doff a certain personal item. Further yet, the member may direct the player to perform a certain dance routine, sing a certain song, a spontaneous expression, etc. In the spirit of sportsmanship and team-building, the player may interact with other players to perform the performance while doffing a personal item.

Similar to the previous embodiment, one of the players may act as a dealer. As such, if one of the players is a dealer, then that player may deal the cards to the other players. In the alternative, the dealer may be provided by the house. If the house provides the dealer, then the job of the dealer would be to deal the cards and keep the play in order. Regardless of whether the house provides a dealer to deal cards, in the game of Texas Hold'em, there may still be a dealer button. The dealer button would then designate the identity of the dealer. Although the player who is designated as the dealer would not actually physically deal cards but it would indicate which player begins the wagering with the small and big blind. The player to the left of the dealer button receives the first card and every player at the table receives a card until each player has received two cards.

In another embodiment, the guests may make side bets with other guests. For the purpose of this application and illustration, guest may be defined as anyone who is not a player who is currently engaged at the poker table. In addition, players may make side bets with other players. Also, there may be side bets made with a combination of players and guests.

The players may place a side bet on the table or by some other means. The guest may have a separate section or some sort of computer program based system where they are able to place a bet. After the current poker game is over, and the five community cards have been dealt, the players with the winning hands may receive a portion of the independent side bet pot, independent of the current poker game. The award amount for the side bet may be predetermined and may depend on the best poker hand that is made with the five community cards. If the underlying game ends without five community cards being dealt, the remaining community cards may be dealt or the side bets may be carried over to the next game until five community cards are dealt.

A progressive pot may also be accumulated for splitting among the side bet players in the event a straight flush, four of a kind, or other improbably hand is obtained by the community cards. Such a progressive pot may become very high and draw new players to the game.

Similar to the previous embodiment, in another embodiment, guests may also place side bets on the community cards, allowing many guests to be indirectly involved in the game. This does not affect the underlying game.

If the game is played live, then the players at the table may have special or different chips from those being played at the table for the current game. In addition, those special chips may be placed on a different section of the poker table.

In a similar fashion, if the game is played live, the guests may accumulate their bets over at a different table and make wagers in a similar fashion.

Furthermore, as previously discussed, there may be more than one member who wishes to interact/play/direct a particular player and a queue may develop. The rules of the house or game may allow for more than one member to interact/play/direct with one player, however, if the rules allow for only one member to interact/play/direct one player at a time, then a queue may form.

The queue may take on many different forms. As a non-limiting example, the queue system may be first-come-first-served. In other words, in this example of the queue, the first person to play with that particular player may be determined in the order in which the person logged in to play with that particular player. Accordingly, the first person to pick that particular player would get to interact with that player first, and then the subsequent members would form a line to take their turn.

As such, once a member waited for their turn for a place at the poker table, once it becomes their turn, then they turn into an Active Player, and they stay at the table until, either that member decides to leave the table, or that member loses all of his money or his points for the game.

Another non-limiting example of the queue may involve the use of a loyalty program. The house may have a loyalty program based on how much money that member has spent. Another loyalty program may factor in how long they have been a member. Yet another non-limiting example of a loyalty program may depend on if the member has a favorite player and that member frequently uses that player. Accordingly, that member may have priority over other non-loyalty members for that member's favorite player.

In the event there are multiple loyalty members vying for the same player, then they may be placed on a standard first-come-first-served queue.

In another embodiment, another method of playing a poker game may include similar step as the previous embodiments. However, in this embodiment, the player chooses a surrogate. For the purposes of this application and for illustrative purposes, a surrogate may be defined as someone who does not actually play the game of poker but is still a part of the game. As discussed previously, in the spirit of sportsmanship and the idea of everybody winning, the winner of the hand doffs a personal item.

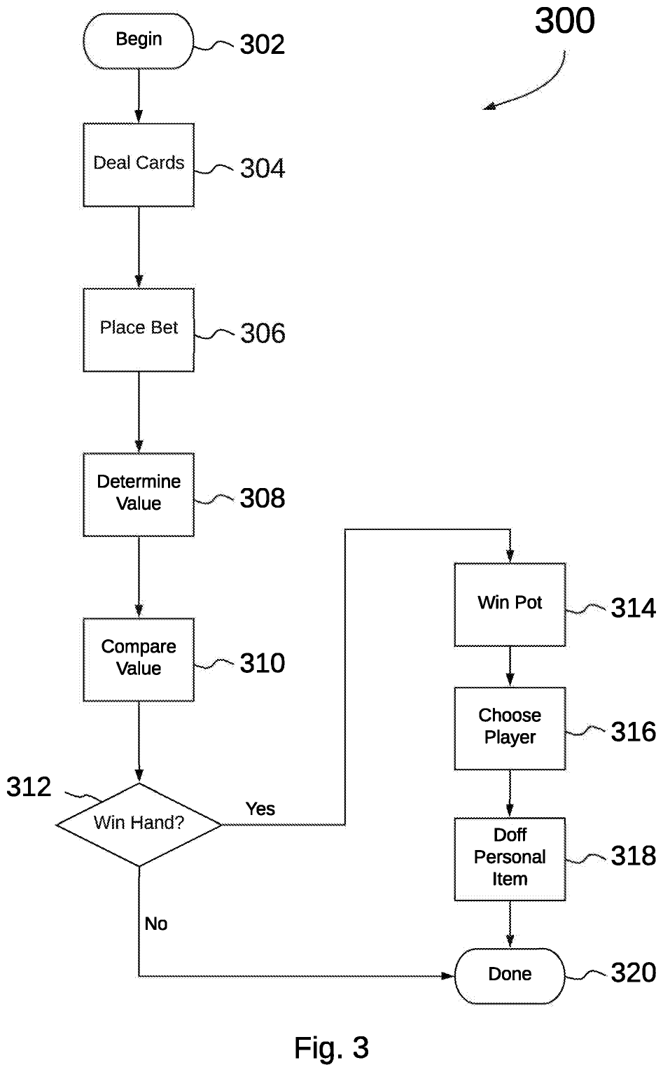

FIG. 3 is an illustration of a method 300 for a poker system and method with one or more embodiments of the present invention. As illustrated, the process begins at step 302 by the players gathering to play poker.

In step 304, the poker game starts when the dealer distributes cards to each of the players. Depending on the type of game, each player receives a number of cards. The player may look at their cards at this point and decide whether to receive more cards or to stay with their current hand.

In step 306, the player may choose to place a wager on the table based on their hand. If they feel they do not have a good hand, then they can fold or give up. Conversely, even if they have a bad hand, they may choose to bluff or pretend to have a better hand than what it appears.

However, at step 308 a determination is made the value of the hand that the player holds. The value of the hand could be a great hand or a weak hand. As previously stated, the determination is made whether to fold, bluff, or to keep on going.

At step 310, when the players are required to show their hand, the players will then compare the value of their hand in relation to the hands of the other players.

At step 312, if the player does not have the highest value hand in relation to the hands of the other players then that player has lost the hand and is no longer in the game and is done at step 320.

Conversely, if the player has the highest value hand in relation to the other player's hands, then that player has won.

At step 314, the player with the wining hand collects the pot or the wagers of all of the players.

In this embodiment, the player collects the pot or wagers at step 314, and then the player chooses another player at step 316.

At step 316 the chosen player doffs or removes a personal item at step 318.

The hand concludes and is done at step 320.

As a non-limiting example, the surrogate may be chosen from a pre-selected group. The group of surrogates may wait in a separate room or in the same room waiting to be chosen. Moreover, the surrogate may have direct communication access to the player and may tease and taunt the player. Conversely, the surrogate may be supportive and encouraging. After the player chooses a surrogate, they would receive some sort of designation by that player, as to claim them. This can be something minor as just picking the person or could get more detailed like assigning a designation on the computer.

As another non-limiting example, like the previous examples, a member may direct the actions of a player, however, in another embodiment, if that member wins, then they may direct another player to doff a personal item.

As previously discussed by using the example of Texas Hold'em, as a non-limiting example, two or more players are dealt a card and the dealer subsequently deals a single card to each player, rotating around the table, until each player has two cards. These hole cards are the hand of the player.

Each of the players place a bet if they are still in the round. As a non-limiting example, in Texas Hold'em, there are four rounds of betting. The “pre-flop” or the first betting round of betting takes place once the hole cards have dealt to all of the players. The player who starts is the player to the left of the player who posted the big blind. That player has three options, call, raise or fold. If the player chooses to call, then that player matches the amount of the big blind. If the player chooses to raise, then that player increases the bet. If the player chooses to fold, then that player adds nothing to the pot and throws away their hand. If the player folds then they are no longer eligible to win the current hand and waits for the next deal. The collective bets are called a pot.

The second betting round occurs after the first pre-flop betting round. The unique part of the second betting round is that it takes place after the first three community cards have been dealt face up. In addition, the player has another option. The player may call, fold, and raise, but in this round they may also check. A player may check if there is no bet during the current round. A check is to decline the chance to bet and is subsequently passed to the next player.

The next round of betting is called the third betting round. The fourth community card or the turn is dealt face up and a new round of betting starts. Once again, the players have an option to call, fold, raise, or check.

The last round or the final betting round begins after the fifth community card or the river is dealt face up. Again, the players have the option call, fold, raise, or check. After all the betting has been completed, the remaining players reveal their cards to determine the winner, this is called the showdown.

During the showdown, the value of each hand is determined. Each player's hand is compared to the hand of the other players. The player who wins Texas Hold'em is the player with the best five-card hand.

When the player with the winning hand wins a portion of the pot, then that player's surrogate may proceed to doff a personal item. As such, in the spirit of giving, that player's surrogate may give that personal item to another player, another surrogate, the house, or any other guest. Then again, that player's surrogate may decide to keep the personal item after the player's surrogate temporarily removes it from their immediate possession.

In addition to the removing of the personal item, the player's surrogate may make it fun and playful. The player's surrogate may perform while removing a personal item. As a non-limiting example, the performance may be dancing, singing, a lap dance, playing a musical instrument, a spontaneous expression, painting, etc. The player's surrogate may perform while removing a personal item such as an item of clothing or jewelry.

Moreover, as previously discussed, the surrogate may wait in a separate room until their respective player wins the hand. As a non-limiting example, the surrogate may leave the room to special performance area. In this performance area, the surrogate may doff an item while performing.

The performance area may take on different forms. As a non-limiting example, the performance area may be a Go-Go Dancer Stage, or a Suspended Dance Cage. In addition, the performance area may be aquatic-based and take on the form of water dancing. The performance area may be related to aerial arts and may use aerial silk, which may be aerial acrobatics while hanging from a fabric.

If the surrogate doffs all of his or her clothing, and yet the member still have enough points to keep on going, then another surrogate may rotate in. Moreover, there may be more than one surrogate chosen by the member and more than one surrogate may be active in the same game.

As a non-limiting example, the poker game may be played in the following manner. If the person is already a member, then the member would log in. The log in may be performed on desktops or be opened on a mobile site through a smart device.

The member may enter their member username and password and then pick an avatar. The avatar may be anything to represent the member in this setting. This may be as simple as a cartoon character or it could be as fun as an animal. It could be a celebrity picture, a car, an emoji, or it could even be a cartoon representation of the member.

The member may see a welcome banner that may display the player's Score History/Summary. The Score History/Summary may be customized to display how long the history will go back in time. It could also be customized to show which player the member used in the past. Furthermore, the display may show the performance of the player or surrogate from the past.

The member may then enter the section that shows Game Rooms Previews. Each Game Room may cater toward each member's preference. As a non-limiting example, the Game Room may consist of physical characteristics of certain people. It may be separated based on hair color, height, weight, color of clothing, performance ability, costumes, or any other distinguishing features. Moreover, there may be theme Game Room. As non-limiting examples, the themes could include the Wild West, Feudal Japan, Colonial times, foreign cultures, or even scenes or categories of movies. As such, the member would select a Game Room.

In the Game Room, there may be a live view of the Players or Surrogates. As a non-limiting example, there may be two to seven Players or Surrogates per Game Room.

The Member may next purchase Playing Credits. As a non-limiting example, the purchase of the Playing Credits may be done so in the following conversion:

| | |
|---|---|
| $10 | 100 pts |
| $15 | 150 pts |
| $20 | 225 pts |
| $25 | 325 pts |
| $30 | 450 pts |
| $35 | 600 pts |
| $40 | 775 pts |
| $45 | 975 pts |
| $50 | 1200 pts |

The member may then pay through the use of a credit card, for example.

The member may then click on any Player or Surrogate to see which member is playing the Player's hand or the Player playing hand playing for the Surrogate. In addition, it may be possible to see how many members are in the queue to play with that Player or Surrogate.

Then the member may pick one Player or Surrogate. If that particular Player or Surrogate is already in play, then the member would wait in the queue. As discussed previously, the queue may involve the use of a Member Loyalty Program or it may be based on when the Player or Surrogate was chosen.

If there are no members in queue behind any particular Player or Surrogate, then a member may select/claim that Player or Surrogate and start playing.

As a non-limiting example, each Player or Surrogate may wear 10 articles of clothing. The clothing may be a jacket, blouse, skirt, lace top, garter, bustier, nylon, heels, necklace, gloves, etc. In addition, the personal items may be or related to costumes, uniforms, etc.

As a non-limiting example, if the particular poker being played is 7-Card Stud, then table antes are 10 pts per player and may be played as follows:
2 cards down, 3rd card up, 1^{st} Bet
4^{th} card up, 2^{nd} Bet, or Fold
5^{th} card up, 3^{rd} Bet, or Fold
6^{th} card up, 4^{th} Bet, or Fold
7^{th} card down, 5^{th} Bet, or Fold

In this particular instance, the minimum bet is 10 pts and the maximum bet is 50 pts, or whatever pts are left on hand.

The member with the winning hand will win the pot. However, as noted previously, the winner will doff an article of clothing. In another instance, the Player will doff an article of clothing. In yet another instance, the Surrogate will doff an article of clothing. In whatever instance, the doffing may be done in a playful way.

The house may take ten percent House Collection per pot. As previously discussed, the other members waiting in the queue may make side bets. They may ante in the pot for each deal and would be subject to House Collection.

At this point a new ante is put up and a new game begins.

This gaming pattern may continue until the end of a series, in other words, when the first Player or Surrogate no longer has any article of clothing to doff. As a non-limiting example, the winning Player or Surrogate may receive 10% of the pot. Once again, in the spirt of sportsmanship and team building, the idea of everybody wins may be apparent. Furthermore, in the spirit of sharing, the house may take a 10 pts “House Collection” every 5 minutes. This may foster a sense of excitement and fun.

Once the member wishes to stop playing, that member may Log Off. All of the winning pts earned may remain saved in the member's Winning Cup! The Winning Cup may be some sort of tracking system where the members compete against each other for the certain designations of achievement or the first to reach a certain level. In order to promote continuous playing, 50% of pts may be credited to the next time the member logs in.

The poker system may take extend to a tournament format. As a non-limiting example, there may be a Semi-Annual Live Poker Tournament that may be held at selected casinos around the country. All of the members would be invited to attend the event. The added attraction for this type of tournament is that the Player or the Surrogates would make live appearances and if their respective member wins the hand, then the performances would be live.

The possibility arises where the top 100 players of the Winning Cup are invited. As a non-limiting example, the top 100 players may be the 100 players with the highest scores. Then again, the top 100 players may be the first 100 players to reach a certain score. Yet again, the top 100 players may be the 100 players that have bought the most points. The 100 top players may receive VIP perks. In addition, the chosen player may designate an Alternate to attend in his or her place.

The Final Tournament, the Live Event, and any other event, the invited “High Rollers (based on winning points) may be included in the VIP Section. The VIP Section may be located close to the Poker Table.

If the members do well in the tournament, they may make it to the next round. The last seven members at the final table may be automatically invited to an annual grand poker tournament.

The grand poker tournament may be held at selected casinos around the country. As a member, they would receive an invitation to attend. Moreover, the Player or the Surrogates would make live appearances and if their respective member wins the hand, then the performances would be live.

Just like the previous round, the top 100 players of the Winning Cup are invited. As a non-limiting example, the top 100 players may be the 100 players with the highest scores. Then again, the top 100 players may be the first 100 players to reach a certain score. Yet again, the top 100 players may be the 100 players that have bought the most points. The 100 top players may receive VIP perks. In addition, the chosen player may designate an Alternate to attend in his or her place.

The next and final round would be a Grand Final Table's Showdown. Just like the previous rounds, the player with the most points at the end wins.

Continuing with the idea of everybody winning, the Player or Surrogate who performs would also win. The actual percentage may be adjusted or determined later, however for the purposes of illustration and as a non-limiting example, the Player or Surrogate may receive a certain percentage of the bets by placed by the members. As such, the more money that is wagered, the Player or Surrogate has the potential for more earnings. The possibility exists where if the Player or Surrogate were to have more charisma or more exciting personality, and then the other Players or members may be more inclined to wager more money. Moreover, as a non-limiting example, the winnings of each series, the Player or Surrogate may receive 10% of the pot. Also, the Player or Surrogate may receive bonuses depending on the house rules.

With the current technology of smartphones, the members may be notified or invited to join in when a certain Player or Surrogate is ready to play.

There may be many different ways for members to sign up; however, for the purposes of a non-limiting example and illustration, the membership sign-up may include the first name, last name, email address, nickname, and avatar. As a special promotion, when the member uses a valid credit card, the first 30 days may be free. In addition, there may be free 100 pts awarded as a sign-in gift and the member would be ready to play. Furthermore, as a non-limiting example, if the member may have the option of after the free 30 days, a recurring $9.99 monthly Fee will be charged as per Terms & Agreements.

Although there may be many different membership fee structures, as a non-limiting example and for illustrative purposes, the first month may be free and the member may be awarded 100 pts of credit. There may be an option for a monthly fee of $9.99, with 100 pts of credit, and a recurring charge after each period. A longer-term option may be available for a 6-month membership with a fee of $59.99, with 1,000 pts of credit, and a recurring charge after each period. There may be an even longer option available. A one-year membership with a fee of $99.99, with 2,500 pts of credit, and a recurring charge after each period.

As a non-limiting example, when a member enters a certain type of Game Room, a “clock” starts ticking. It may be some nominal value, but it would add to the fun when the member puts a little effort into the game. As such, the member's points will be used accordingly.

As another non-limiting example, there may be guests or members who do not wish to play poker and maybe there to watch. In this instance, the Game Room may appeal to the guests' or members' voyeuristic appetite. As a possibility, that person may pay extra to enter the Game Room in stealth mode. In stealth mode, the member or guest may visit one or many Game Rooms and not be detected. As such, that member or guest may be anonymous and just enjoy the show.

One of the features of the poker game is for the player or surrogate to doff a personal item. However, in order to add to the excitement of the game, there may be a reverse doff system. In this variation, if the member or player keeps on losing hand after hand, the player or surrogate who doffed an item of clothing may be required to put that article of clothing or some other article of clothing back on.

As a non-limiting example and for illustrative purposes in the present application, Texas Hold'em was explored. However, any variation of poker or any other game may use the features of the winner, member, or surrogate may doff a personal item. Furthermore, as a non-limiting example, some variations of poker may include Seven-Card Stud, Draw Poker, Hi-low, Omaha, etc.

Every player receives seven cards, which are dealt face down.

Players examine their cards, discard two, and play their best five by placing their hand in a designated area on the table. Preferably, discarded cards are placed in a designated discard area.

After all players have made their discards, the dealer turns over its hand, discards two cards, and plays its best five. Preferably, the dealer places its hand in full view of the players, in front of the chip tray. Again, discarded cards are preferably placed in designated discard area.

Once the dealer band is exposed, players may not touch their cards or reset their hands.

The dealer will take the player cards, working one position at a time, and turn them over and spread them on the table so that the hand value may be determined and displayed to all players. The dealer compares the dealer hand to each player hand, individually. If there are bonus bets, the dealer will also compare the player hands to a bonus pay table. To make the comparison between player and dealer hands, the dealer will use a designated hand ranking system, which may be the traditional poker ranking system.

If the player hand is better than the dealer hand, the player wins the opening bet, and the dealer will pay the player. If the player's hand is worse than the dealer's hand, the player loses and the dealer will take the player's opening bet and the rules may provide that a tie results in a player loss or a push (i.e., a return of the player wager), as desired.

If the player has additionally made a low range bonus bet based on his or her own hand, the dealer will also compare the player hand to the first bonus bet pay table. If the player hand appears on the pay table, the dealer will pay the player as provided by the first bonus bet pay table. If the player hand does not appear on the pay table, the dealer will take the player's bonus bet.

If the player has made a high range bonus bet, the dealer will leave all player hands on the table, until the dealer has compared each player hand individually to the dealer hand. After that comparison, the dealer will determine, for each player who has made a high range bonus bet, the outcome of such bet by a comparison of all player hands to the second bonus bet pay table.

In addition, whether before or after determining the outcome of any high range bonus bet, the dealer will also determine the outcome of the pot bets. This is accomplished by comparing all hands, including all player hands and dealer hands, and then awarding the pot bets to the highest hand. In one embodiment, a tie between highest hands, including where one of the hands is a dealer hand, results in a sharing of the pot between the tying hands.

It may be desired to provide that winning opening wagers are paid even money, subject to a commission for the house. For example, it may be provided that all winning bets will be charged a 5% commission, which will be collected immediately by the dealer. Such a commission may be charged in increments of 25 cents. Thus, where a player has placed a winning bet of $25, the 5% commission will be $1.25. The commission on odd unit bets may be charged on the next highest unit. For example, where a player bets $28 and wins, the bet the commission would be $1.50, the same as it would be on a $30 bet. Preferably, no commission is charged on the pot or bonus payout, though one may be charged if desired.

In an embodiment, a Joker may be utilized. As a non-limiting example, the Joker may be used to fill any Straights or Flushes, to pair up, to use as the third card with any pair for a Three of a Kind, to use as of the fourth card with a three of a kind for Four of a Kind or to use as the fifth card with four more Aces. The ranking of the hands may be as follows:
Highest hand: Five of a Kind (four Aces plus one Joker)
   Royal Flush (natural, without a Joker)
   Royal Flush (with the Joker)
   Straight Flush (no Joker) (Note—the Highest rank Flush or
   Straight Flush: A-K-Q-J-10, the second highest Flush or
   Straight Flush: A-2-34-5)
   Straight Flush (with Joker)
   Four of a Kind (no Joker)
   Four of a Kind (three of Kind plus the Joker)
   Full House (no Joker)
   Full house (with Joker), (unless two Aces plus the
   Joker) Flush (no Joker)
   Flush (with Joker)
   Straight (no Joker)
   Straight (with Joker)
   Three of a Kind (no Joker), (except two Aces and the Joker)
   Three of a Kind Pair and the Joker)
   Two Pair (no Joker)
   Two Pair (with Joker), (unless one pair contains an Ace and
   Joker)
   One Pair (no Joker)
   One Pair (with Joker), (except the pair is an Ace with the Joker)

The following table illustrates hand value probabilities:

| HAND | COMBINATIONS | PROBABILITY |
|---|---|---|
| Five Aces | 1128 | 0.00000732 |
| Straight/Royal | 210964 | 0.00136862 |
| Four of a Kind | 307472 | 0.00199472 |
| Full House | 4188528 | 0.02717299 |
| Flush | 6172088 | 0.04004129 |
| Straight | 11236028 | 0.07289350 |
| Three of a Kind | 7470676 | 0.04846585 |
| Two Pair | 35553816 | 0.23065464 |
| Pair | 64221960 | 0.41663862 |
| Nothing | 24780420 | 0.16076246 |
| Total | 154143080 | 1 |

The following table illustrates the probability outcome of each hand:

| 5-Card | 5-card hand | 2-Card hand | 2-Card hand |
|---|---|---|---|
| 9 high | 0.0002 | 3-2 | 0.0007 |
| 10 high | 0.0018 | 4-2 | 0.0021 |
| Jack | 0.0081 | 4-3 | 0.0034 |
| Q-5 | 0.0086 | 5-2 | 0.0046 |
| Q-6 | 0.0108 | 5-3 | 0.0057 |
| Q-7 | 0.0154 | 5-4 | 0.0068 |
| Q-8 | 0.0209 | 6-2 | 0.0079 |
| Q-9 | 0.0247 | 6-3 | 0.0089 |
| Q-10 | 0.0257 | 6-4 | 0.0099 |
| Q-J | 0.0257 | 6-5 | 0.0108 |
| K-5 | 0.0265 | 7-2 | 0.0118 |
| K-6 | 0.0299 | 7-3 | 0.0128 |
| K-7 | 0.0374 | 7-4 | 0.0138 |
| K-8 | 0.0479 | 7-5 | 0.0149 |
| K-9 | 0.0586 | 7-6 | 0.0164 |
| K-10 | 0.0654 | 8-2 | 0.0178 |
| K-J | 0.0671 | 8-3 | 0.0187 |
| K-Q | 0.0671 | 8-4 | 0.0196 |
| A-6 | 0.0671 | 8-5 | 0.0206 |
| A-7 | 0.0829 | 8-6 | 0.0222 |
| A-8 | 0.1019 | 8-7 | 0.0259 |
| A-9 | 0.1245 | 9-2 | 0.0292 |
| A-10 | 0.1453 | 9-3 | 0.0301 |
| A-J | 0.1575 | 9-4 | 0.0309 |
| A-Q | 0.1608 | 9-5 | 0.0319 |
| A-K | 0.1608 | 9-6 | 0.0335 |
| Pair of | 0.1729 | 9-7 | 0.0376 |
| Pair of | 0.2048 | 9-8 | 0.0472 |
| Pair of | 0.2377 | 10-2 | 0.0543 |
| Pair of | 0.2716 | 10-3 | 0.0553 |
| Pair of | 0.3067 | 10-4 | 0.0563 |
| Pair of | 0.3432 | 10-5 | 0.0574 |
| Pair of | 0.3842 | 10-6 | 0.0591 |
| Pair of | 0.4274 | 10-7 | 0.0632 |
| Pair of | 0.4691 | 10-8 | 0.073 |
| Pair of | 0.5125 | 10-9 | 0.0921 |
| Pair of | 0.564 | J-2 | 0.105 |
| Pair of | 0.6184 | J-3 | 0.1062 |
| Pair of | 0.6852 | J-4 | 0.1073 |
| 2 Pair | 0.7503 | J-5 | 0.1085 |
| 2 Pair | 0.7543 | J-6 | 0.1102 |
| 2 Pair | 0.7601 | J-7 | 0.1142 |
| 2 Pair | 0.7676 | J-8 | 0.1232 |
| 2 Pair | 0.7767 | 1-9 | 0.1414 |
| 2 Pair | 0.7867 | J-10 | 0.1729 |
| 2 Pair | 0.7969 | Q-2 | 0.1931 |
| 2 Pair | 0.8074 | Q-3 | 0.1945 |
| 2 Pair | 0.8146 | Q-4 | 0.1957 |
| 2 Pair | 0.8203 | Q-5 | 0.197 |
| 2 Pair | 0.8257 | Q-6 | 0.1989 |
| 2 Pair | 0.8261 | Q-7 | 0.2027 |
| Three | 0.8286 | Q-8 | 0.2109 |
| Three | 0.8340 | Q-9 | 0.2269 |
| Three | 0.8393 | Q-10 | 0.2551 |
| Three | 0.8446 | Q-J | 0.2994 |
| Three | 0.8499 | K-2 | 0.3268 |
| Three | 0.8552 | K-3 | 0.3285 |
| Three | 0.8609 | K-4 | 0.3302 |
| Three | 0.8665 | K-5 | 0.3323 |
| Three | 0.8718 | K-6 | 0.3350 |
| Three | 0.8771 | K-7 | 0.3398 |
| Three | 0.8823 | K-8 | 0.3487 |
| Three | 0.8876 | K-9 | 0.3641 |
| Three | 0.8909 | K-10 | 0.3895 |
| Straight | 0.9030 | K-J | 0.4291 |
| Straight | 0.9105 | K-Q | 0.4858 |
| Straight | 0.9176 | A-2 | 0.5196 |
| Straight | 0.9211 | A-3 | 0.5217 |
| Straight | 0.9246 | A-4 | 0.5242 |
| Straight | 0.9316 | A-5 | 0.5272 |
| Straight | 0.9385 | A-6 | 0.5312 |
| Straight | 0.9453 | A-7 | 0.5378 |
| Straight | 0.9522 | A-8 | 0.5483 |
| Straight | 0.9623 | A-9 | 0.5647 |
| Flush 6 | 0.9654 | A-10 | 0.5892 |
| Flush 7 | 0.9659 | A-J | 0.6248 |
| Flush 8 | 0.9662 | A-Q | 0.6744 |
| Flush 9 | 0.9668 | A-K | 0.7409 |
| Flush10 | 0.9682 | Pair of 2's | 0.7899 |
| Flush J | 0.9705 | Pair of 3's | 0.8116 |
| Flush Q | 0.9744 | Pair of 4's | 0.8320 |
| Flush K | 0.9804 | Pair of 5's | 0.8512 |
| Flush A | 0.9974 | Pair of 6's | 0.8693 |
| Full | 0.9984 | Pair of 7's | 0.8884 |
| 4 of a | 0.9995 | Pair of 8's | 0.9083 |
| Straight | 1 | Pair of 9's | 0.9268 |
| Five | 1 | Pair of 10's | 0.9439 |
| Pair of Jacks | 0.9593 | | |
| Pair of Queens | 0.9726 | | |
| Pair of Kings | 0.9839 | | |
| Pair of Aces | 0.9945 | | |

Another non-limiting example of how the system may work include, logging by username and password, enter a valid credit card number, and pick an avatar to represent the member. Once the member/guest/player enters the system, there may be a welcome banner with the score history and summary. There may be other sections such as a dashboard for more detailed info, and game room previews. As a non-limiting example, there may be a VIP game room reserved for the high rollers, this may be designated as the platinum membership.

In this platinum membership, there may be pictures, GIFs or live views of the poker performers or players, between two to seven players. The member/guest/player may then purchase a token or a chip. As a non-limiting example, the token or chip may be electronic, cash-based, cryptocurrency, or any other form of marker that acts a representation of value.

As a non-limiting example, if the token or chips were to be purchased, a single US dollar may purchase one chip. As another non-limiting example, each unit may exchange to ten gold chips (US $1) or two silver chips (US $0.50). A non-limiting example of the exchange rate may be as follows:
US $10 exchanges to 10 chips, then to 10 gold chips, or 20 silver chips
US $20 exchanges to 20 chips, then to 20 gold chips, or 40 silver chips
US $50 exchanges to 55 chips, then to 55 gold chips, or 110 silver chips
US $100 exchanges to 110 chips, then to 110 gold chips, or 220 silver chips
US $200 exchanges to 240 chips, then to 240 gold chips, or 480 silver chips
US $300 exchanges to 360 chips, then to 360 gold chips, or 720 silver chips
US $400 exchanges to 560 chips, then to 560 gold chips, or 1,120 silver chips
US $500 exchanges to 750 chips, then to 750 gold chips, or 1,500 silver chips

Then the member/guest/player may make a payment through their credit card and authorize the payment to go through. Next, they may click on a list of Avatars to see who is playing each poker player's hand whether it is a player or performer, and how many members are in the game queue.

If all the performers have been chosen by the other members, a newly signed-in member may then pick (the pick may be timestamped) a performer and wait in the game queue. The VIP members may have a higher priority position on the queue list. If there aren't any members in the queue list behind any particular performer, then the member can select/claim that particular performer's playing spot and start playing.

In this embodiment, the performer may wear 10 articles of clothing, as non-limiting examples, jacket, blouse, skirt, lace top, garter, bustier, nylon, heels, necklace, gloves, etc. The table antes may be a certain number of chips per player, and it may be 7-Card Stud, 5-Card Draw, or any other assorted card game of skill, in the following manner:
2 cards down, 3rd card up, 1^{st} Bet
4^{th} card up, 2^{nd} Bet, or Fold
5^{th} card up, 3^{rd} Bet, or Fold
6^{th} card up, 4^{th} Bet, or Fold
7^{th} card down, 5^{th} Bet, or Fold

There may be a minimum bet, a maximum bet. The winning hand's poker performer may remove one cloth item in a playful way. The house takes a 10% house collection per pot, per game. Moreover, members waiting in the queue, may also ante in the pot for each deal, and subject to house collection. There may be a new ante, at each new game. There may be a re-purchase of points, however, members cannot re-purchase new pts during an active game. At the end of a series may be when the first poker performer may be left without any articles of personal items. The winning poker performer may receive 10% of the pot. The house may take a certain percentage of the tokens or on a time basis or per game. When the members stop playing, then they may log off. All the winning token that are earned may remain saved in the member's wining cup, in the player's dashboard. If there is a zero balance, the member may purchase more tokens or value at the log-in session.

Moreover, there may be a semi-annually live poker tournament held at selected casinos around the world. All Members may be invited to attend. The top poker performers may make live appearances. Also, the top members in winnings may be invited, with VIP perks, or may designate an alternate to attend. The final table's members may be automatically invited to the annual grand poker tournament.

In another embodiment, the poker performers earnings may be related to the number of bets by placed by the members. The performers may receive a percentage of the pot, bonuses, and special invitation to events. Also, there may be a referral service, so each new performer that is recruited may result in a bonus.

As discussed previously, current currency may be converted into a chip or token. Each chip balances may be stored on the member's dashboard. Conversely, the chips may be converted back into currency such as the US Dollar. The chips may also be used to “tip” a performer, may be redeemed to purchase gifts, from any affiliated stores, may be redeemed to purchase online chat time with selected performers, may be redeemed to sign on to affiliated websites, may be redeemed to reserve affiliate hotels, may be redeemed as a “door charge” at affiliated clubs, and may be the universally accepted entertainment currency, and each member's chip redemption history may be stored at the member's dashboard.

In another embodiment, a website may be devoted to a combination of all the hottest trend in online entertainment such as poker games, performers performing, community chat rooms, virtual reality (VR), augmented reality (AR), mixed reality (MR), 3D video, limitless digital contents on demand, etc.

As stated previously, in another embodiment, the any card game or other games of skills may use the features described. The chips may be exchanged for currency and then redeemed for bartered value such as online purchases, hotel credits, restaurant credits, car services credits, club admissions, live poker tournaments, online VIP (or guest) membership credits, etc. Moreover, the performers may earn income by participating in live card games, performing receiving a percentage of the bets placed, tips, gifts, build up a fan base, online chat session, private performances, recruiting multi-level residual income potentials, live appearances, company sponsored live events, and company sponsored poker tournaments.

In other embodiments, each room may be a chosen environment/space. The member may connect through an internet enabled HD camera, that can do one-on-one poker game, where members may place their bets, and win or lose their account value, and be entertained. Depending on the plan or value, the resolution of the connection may be controlled based on the betting level or other monetary levels.

In other embodiments, the poker method and system may be directed may be implemented by the use of a computer, internet, computing device, etc.

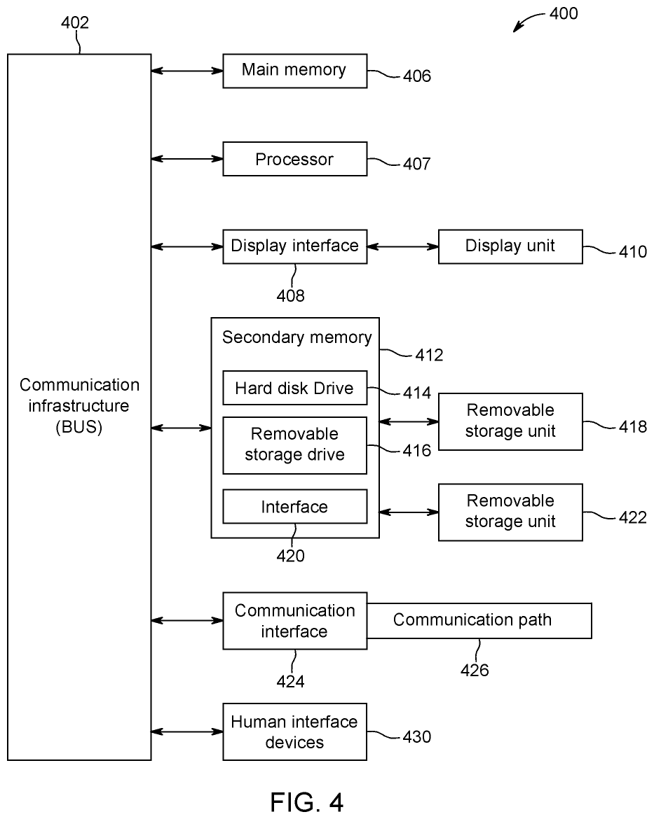

FIG. 4 diagrams a general-purpose computer and peripherals 400, when programmed as described herein, may operate as a specially programmed computer capable of implementing one or more methods, apparatus and/or systems of the solution described in this disclosure. Processor 407 may be coupled to bi-directional communication infrastructure 402 such as communication infrastructure system bus 402. Communication infrastructure 402 may generally be a system bus that provides an interface to the other components in the general-purpose computer system such as processor 407, main memory 406, display interface 408, secondary memory 412 and/or communication interface 424.

Main memory 406 may provide a computer readable medium for accessing and executed stored data and applications. Display interface 408 may communicate with display unit 410 that may be utilized to display outputs to the user of the specially-programmed computer system. Display unit 410 may comprise one or more monitors that may visually depict aspects of the computer program to the user. Main memory 406 and display interface 408 may be coupled to communication infrastructure 402, which may serve as the interface point to secondary memory 412 and communication interface 424. Secondary memory 412 may provide additional memory resources beyond main memory 406, and may generally function as a storage location for computer programs to be executed by processor 407. Either fixed or removable computer-readable media may serve as Secondary memory 412. Secondary memory 412 may comprise, for example, hard disk 414 and removable storage drive 416 that may have an associated removable storage unit 418. There may be multiple sources of secondary memory 412 and systems implementing the solutions described in this disclosure may be configured as needed to support the data storage requirements of the user and the methods described herein. Secondary memory 412 may also comprise interface 420 that serves as an interface point to additional storage such as removable storage unit 422. Numerous types of data storage devices may serve as repositories for data utilized by the specially programmed computer system. For example, magnetic, optical or magnetic-optical storage systems, or any other available mass storage technology that provides a repository for digital information may be used.

Communication interface 424 may be coupled to communication infrastructure 402 and may serve as a conduit for data destined for or received from communication path 426. A network interface card (NIC) is an example of the type of device that once coupled to communication infrastructure 402 may provide a mechanism for transporting data to communication path 426. Computer networks such Local Area Networks (LAN), Wide Area Networks (WAN), Wireless networks, optical networks, distributed networks, the Internet or any combination thereof are some examples of the type of communication paths that may be utilized by the specially program computer system. Communication path 426 may comprise any type of telecommunication network or interconnection fabric that can transport data to and from communication interface 424.

To facilitate user interaction with the specially programmed computer system, one or more human interface devices (HID) 430 may be provided. Some examples of HIDs that enable users to input commands or data to the specially programmed computer may comprise a keyboard, mouse, touch screen devices, microphones or other audio interface devices, motion sensors or the like, as well as any other device able to accept any kind of human input and in turn communicate that input to processor 407 to trigger one or more responses from the specially programmed computer are within the scope of the system disclosed herein.

While FIG. 4 depicts a physical device, the scope of the system may also encompass a virtual device, virtual machine or simulator embodied in one or more computer programs executing on a computer or computer system and acting or providing a computer system environment compatible with the methods and processes of this disclosure. In one or more embodiments, the system may also encompass a cloud computing system or any other system where shared resources, such as hardware, applications, data, or any other resource are made available on demand over the Internet or any other network. In one or more embodiments, the system may also encompass parallel systems, multi-processor systems, multi-core processors, and/or any combination thereof. Where a virtual machine, process, device or otherwise performs substantially similarly to that of a physical computer system, such a virtual platform will also fall within the scope of disclosure provided herein, notwithstanding the description herein of a physical system such as that in FIG. 4.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claim and its equivalents.

What is claimed is:

1. A method of playing a poker game comprising the steps of:
dealing cards to two or more players, wherein the respective dealt cards comprise a hand of that player;
receiving a bet by each of the players, wherein collective bets comprise a pot;
determining a value of each hand;
comparing the value of each hand;
awarding an amount of the pot to the player with a winning hand; and
doffing a personal item by the player with the winning hand.

2. The method of claim 1, wherein one of the players is a dealer.

3. The method of claim 2, wherein the players receive cards from the dealer.

4. The method of claim 1, wherein a guest makes a side bet with other guests.

5. The method of claim 1, wherein the personal item is an article of clothing.

6. The method of claim 1, wherein the personal item is a piece of jewelry.

7. The method of claim 1, further comprising the step of performing.

8. The method of claim 7, wherein the step of performing comprises singing.

9. The method of claim 7, wherein the step of performing comprises dancing.

10. A method of playing a poker game comprising the steps of:
dealing cards to two more players, wherein the respective dealt cards comprise a hand of that player;
directing actions of each respective player by a respective member;
receiving a bet by each of the players, wherein collective bets comprise a pot;
determining a value of each hand;
comparing the value of each hand;
awarding an amount of the pot to the player with a winning hand; and
doffing a personal item by the player with the winning hand.

11. The method of claim 10, wherein one of the players is a dealer.

12. The method of claim 11, wherein the players receive cards from the dealer.

13. The method of claim 10, wherein a guest is able to make a side bet with other guests.

14. The method of claim 10, wherein the personal item is an article of clothing.

15. The method of claim 10, wherein the personal item is a piece of jewelry.

16. The method of claim 10, further comprising the step of performing.

17. The method of claim 16, wherein the step of performing comprises singing.

18. The method of claim 16, wherein the step of performing comprises dancing.

19. The method of claim 10, wherein a queue is developed when there is more than one member that waits to direct a particular player.

20. A method of playing a poker game comprising the steps of:
dealing cards to two or more players, wherein the respective dealt cards comprise a hand of that player;
receiving a bet by each of the players, wherein collective bets comprise a pot;
determining a value of each hand;
comparing the value of each hand;
awarding an amount of the pot to the player with a winning hand; and
doffing a personal item by the player chosen by the player with the winning hand.
